(19) United States
(12) Patent Application Publication
(10) Pub. No.: US 2015/0177953 A1
(43) Pub. Date: Jun. 25, 2015

(54) USER INTERFACE DISPLAYING SCENE DEPENDENT ATTRIBUTES

(71) Applicant: THOMSON LICENSING, Issy de Moulineaux (FR)

(72) Inventor: Jagjeet Khalsa, San Diego, CA (US)

(73) Assignee: THOMSON LICENSING, Issy de Moulineaux (FR)

(21) Appl. No.: 14/139,132

(22) Filed: Dec. 23, 2013

(51) Int. Cl. G06F 3/0484; G06F 3/0482

(52) U.S. Cl. CPC G06F 3/04842; G06F 3/0482

(57) ABSTRACT

A method and apparatus for interacting with content data is provided. A current time point for a frame of the content data is determined and at least one user selectable media object included in the frame at the current time point and that occurs at least one further time point of the content data is identified. At least one media object identifier associated with the identified at least one user selectable media object is acquired a user interface display image including the frame of content and the at least one media object identifier is generated. The user interface display image enables selection, by a user, of the at least one media object identifier and automatically initiating playback of the content at the at least one further time point in response to selection of the at least one media object identifier.

### TECHNICAL FIELD OF THE INVENTION

The present disclosure generally relates to digital content systems and, more particularly, to a system, method and graphic user interface enabling user access to at least a portion of digital content based on objects within the digital content.

### BACKGROUND OF THE INVENTION

Home entertainment systems, including television and media centers, are converging with the Internet and providing access to a large number of available sources of content, such as video, movies, TV programs, music, etc. This expansion in the number of available sources necessitates a new strategy for navigating a media interface associated with such systems and enabling access to certain portions of media content being consumed by the user.

Each piece of content includes different actors, scenes, music etc. and, should a viewer enjoy a particular one of these actors, scenes, music, etc., the viewer is left to engage a trick mode or use some other manual scan of the content to try to locate a portion of the content that is desirable to the user. One drawback associated with this manual scan is that it is time consuming for the user. Another drawback associated with this manual scan is that engaging in such a scan may be resource intensive for the system that is receiving, decoding or performing other processing on the data file or stream including the content. The desire to quickly navigate within media content creates an interface challenge that has not yet been successfully solved in the field of home media entertainment. This challenge involves presenting users with a streamlined user interface that facilitates quick navigation within media content without requiring a user to engage in manual seeking.

Additionally, with the increased interconnection between devices that receive and play media with other sources of information about the media content, it is desirable to provide that information to the user while the user is consuming the content. Thus, a further interface challenge is presented when seeking to provide the user with the ability to link media content being viewed with information about the media content. In prior systems, a user needed pre-existing knowledge of items within the content and knowledge about the sources of additional information. To acquire this information, the user had to actively search and/or browse to these sources, navigate through them and determine what information at the sources is relevant to the media content being consumed. The drawback associated with this manner of acquiring additional information about media content is the time consuming distraction it creates when viewing the media content. To obtain this information about some aspect of the media content being consumed, the user's attention is diverted from the actual media content for an extended period of time without a guarantee of actually obtaining the additional information that may be found useful.

The present disclosure is directed towards overcoming these drawbacks.

### SUMMARY

In one embodiment, a method of interacting with multimedia content data is provided. A current time point for a frame of the multimedia content data is determined and at least one user selectable media object included in the frame at the current time point and that occurs at least one further time point of the multimedia content data is identified. At least one media object identifier associated with the identified at least one user selectable media object is acquired in a user interface display image including the frame of multimedia content and the at least one media object identifier is generated. The user interface display image enables selection, by a user, of the at least one media object identifier and automatically initiates playback of the multimedia content at the at least one further time point in response to selection of the at least one media object identifier.

In another embodiment, an apparatus for interacting with multimedia content data is provided. A controller determines a current time point for a frame of the multimedia content data, identifies at least one user selectable media object included in the frame at the current time point and that occurs at least one further time point of the multimedia content data, and acquires at least one media object identifier associated with the identified at least one user selectable media object. A user interface generator coupled to the controller for generating a user interface display image including the frame of multimedia content and the at least one media object identifier, the generated user interface enables selection, by a user, of the at least one media object identifier and the controller automatically initiates playback of the multimedia content at the at least one further time point in response to selection of the at least one media object identifier.

### BRIEF DESCRIPTION OF THE DRAWINGS

These and other aspects, features and advantages of the present disclosure will be described or become apparent from the following detailed description of the preferred embodiments, which is to be read in connection with the accompanying drawings.

In the drawings, wherein like reference numerals denote similar elements throughout the views:

FIG. 1 is a block diagram of an exemplary system for delivering video content in accordance with the present disclosure;

FIG. 2 is a block diagram of an exemplary set-top box/digital video recorder (DVR) in accordance with the present disclosure;

FIG. 3 is an exemplary tablet and/or second screen device in accordance with an embodiment of the present disclosure;

FIG. 4 is an exemplary remote controller in accordance with an embodiment of the present disclosure;

FIGS. 5-7 illustrate exemplary user interfaces in accordance with the present disclosure; and

FIG. 8 is an exemplary flowchart of the method in accordance with the present disclosure.

It should be understood that the drawing(s) is for purposes of illustrating the concepts of the disclosure and is not necessarily the only possible configuration for illustrating the disclosure.

### DETAILED DESCRIPTION OF PREFERRED EMBODIMENTS

It should be understood that the elements shown in the figures may be implemented in various forms of hardware, software or combinations thereof. Preferably, these elements are implemented in a combination of hardware and software on one or more appropriately programmed general-purpose devices, which may include a processor, memory and input/output interfaces. Herein, the phrase “coupled” is defined to mean directly connected to or indirectly connected with through one or more intermediate components. Such intermediate components may include both hardware and software based components.

The present description illustrates the principles of the present disclosure. It will thus be appreciated that those skilled in the art will be able to devise various arrangements that, although not explicitly described or shown herein, embody the principles of the disclosure and are included within its spirit and scope.

All examples and conditional language recited herein are intended for instructional purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read only memory (“ROM”) for storing software, random access memory (“RAM”), and nonvolatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein.

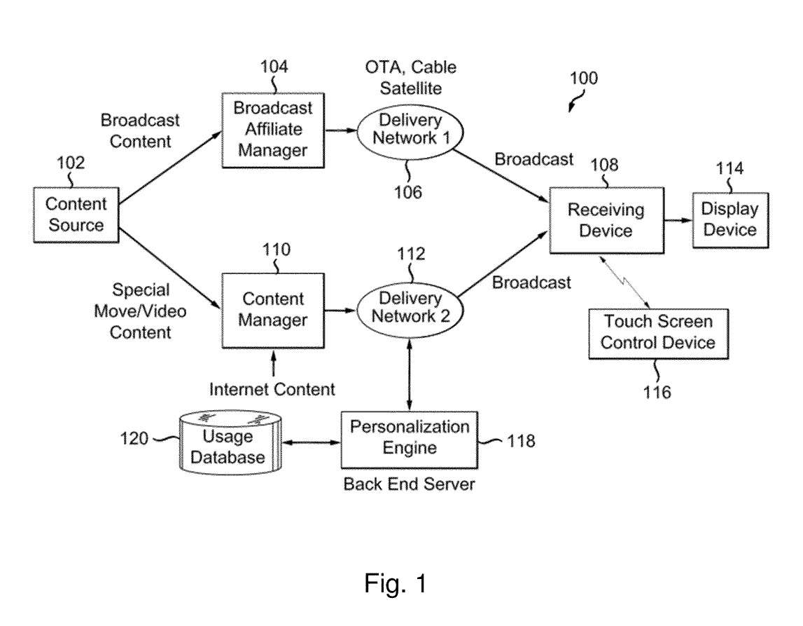

Turning now to FIG. 1, a block diagram of an embodiment of a system 100 for delivering content to a home or end user is shown. The content originates from a content source 102, such as a movie studio or production house. The content may be supplied in at least one of two forms. One form may be a broadcast form of content. The broadcast content is provided to the broadcast affiliate manager 104, which is typically a national broadcast service, such as the American Broadcasting Company (ABC), National Broadcasting Company (NBC), Columbia Broadcasting System (CBS), etc. The broadcast affiliate manager may collect and store the content, and may schedule delivery of the content over a delivery network, shown as delivery network 1 (106). Delivery network 1 (106) may include satellite link transmission from a national center to one or more regional or local centers. Delivery network 1 (106) may also include local content delivery using local delivery systems such as over the air broadcast, satellite broadcast, or cable broadcast. The locally delivered content is provided to a receiving device 108 in a user's home, where the content will subsequently be searched by the user. It is to be appreciated that the receiving device 108 can take many forms and may be embodied as a set top box/digital video recorder (DVR), a gateway, a modem, etc. Further, the receiving device 108 may act as entry point, or gateway, for a home network system that includes additional devices configured as either client or peer devices in the home network.

A second form of content is referred to as special content. Special content may include content delivered as premium viewing, pay-per-view, or other content otherwise not provided to the broadcast affiliate manager, e.g., movies, video games or other video elements. In many cases, the special content may be content requested by the user. The special content may be delivered to a content manager 110. The content manager 110 may be a service provider, such as an Internet website, affiliated, for instance, with a content provider, broadcast service, or delivery network service. The content manager 110 may also incorporate Internet content into the delivery system. The content manager 110 may deliver the content to the user's receiving device 108 over a separate delivery network, delivery network 2 (112). Delivery network 2 (112) may include high-speed broadband Internet type communications systems. It is important to note that the content from the broadcast affiliate manager 104 may also be delivered using all or parts of delivery network 2 (112) and content from the content manager 110 may be delivered using all or parts of delivery network 1 (106). In addition, the user may also obtain content directly from the Internet via delivery network 2 (112) without necessarily having the content managed by the content manager 110.

Several adaptations for utilizing the separately delivered content may be possible. In one possible approach, the special content is provided as an augmentation to the broadcast content, providing alternative displays, purchase and merchandising options, enhancement material, etc. In another embodiment, the special content may completely replace some programming content provided as broadcast content. Finally, the special content may be completely separate from the broadcast content, and may simply be a media alternative that the user may choose to utilize. For instance, the special content may be a library of movies that are not yet available as broadcast content.

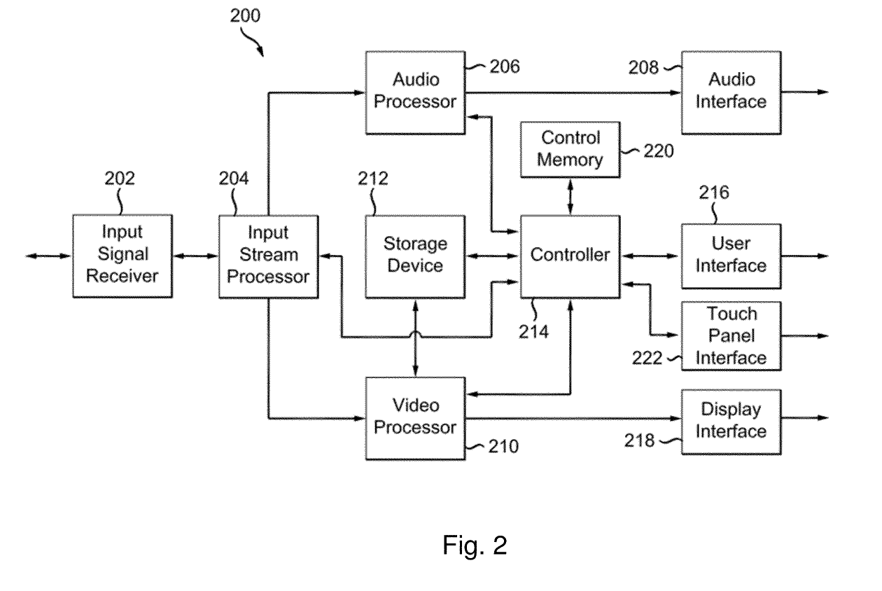

The receiving device 108 may receive different types of content from one or both of delivery network 1 and delivery network 2. The receiving device 108 processes the content, and provides a separation of the content based on user preferences and commands. The receiving device 108 may also include a storage device, such as a hard drive or optical disk drive, for recording and playing back audio and video content. Further details of the operation of the receiving device 108 and features associated with playing back stored content will be described below in relation to FIG. 2. The processed content is provided to a display device 114. The display device 114 may be a conventional 2-D type display or may alternatively be an advanced 3-D display.

The receiving device 108 may also be interfaced to a second screen such as a touch screen control device 116. The touch screen control device 116 may be adapted to provide user control for the receiving device 108 and/or the display device 114. The touch screen device 116 may also be capable of displaying video content. The video content may be graphics entries, such as user interface entries (as discussed below), or may be a portion of the video content that is delivered to the display device 114. The touch screen control device 116 may interface to receiving device 108 using any well known signal transmission system, such as infra-red (IR) or radio frequency (RF) communications and may include standard protocols such as infra-red data association (IRDA) standard, Wi-Fi, Bluetooth and the like, or any other proprietary protocols. Operations of touch screen control device 116 will be described in further detail below.

In the example of FIG. 1, system 100 also includes a back end server 118 and a usage database 120. The back end server 118 includes a personalization engine that analyzes the usage habits of a user and makes recommendations based on those usage habits. The usage database 120 is where the usage habits for a user are stored. In some cases, the usage database 120 may be part of the back end server 118. In the present example, the back end server 118 (as well as the usage database 120) is connected to the system 100 and accessed through the delivery network 2 (112). In an alternate embodiment, the usage database 120 and backend server 118 may be embodied in the receiving device 108. In a further alternate embodiment, the usage database 120 and back end server 118 may be embodied on a local area network to which the receiving device 108 is connected.

Turning now to FIG. 2, a block diagram of an embodiment of a receiving device 200 is shown. Receiving device 200 may operate similar to the receiving device described in FIG. 1 and may be included as part of a gateway device, modem, set-top box, or other similar communications device. The device 200 shown may also be incorporated into other systems including an audio device or a display device. In either case, several components necessary for complete operation of the system are not shown in the interest of conciseness, as they are well known to those skilled in the art. In one exemplary embodiment, the receiving device 200 may be a set top box coupled to a display device (e.g. television).

In the device 200 shown in FIG. 2, the content is received by an input signal receiver 202. The input signal receiver 202 may be one of several known receiver circuits used for receiving, demodulation, and decoding signals provided over one of the several possible networks including over the air, cable, satellite, Ethernet, fiber and phone line networks. The desired input signal may be selected and retrieved by the input signal receiver 202 based on user input provided through a control interface or touch panel interface 222. Touch panel interface 222 may include an interface for a touch screen device. Touch panel interface 222 may also be adapted to interface to a cellular phone, a tablet, a mouse, a high end remote or the like.

The decoded output signal is provided to an input stream processor 204. The input stream processor 204 performs the final signal selection and processing, and includes separation of video content from audio content for the content stream. The audio content is provided to an audio processor 206 for conversion from the received format, such as compressed digital signal, to an analog waveform signal. The analog waveform signal is provided to an audio interface 208 and further to the display device or audio amplifier. Alternatively, the audio interface 208 may provide a digital signal to an audio output device or display device using a High-Definition Multimedia Interface (HDMI) cable or alternate audio interface such as via a Sony/Philips Digital Interconnect Format (SPDIF). The audio interface may also include amplifiers for driving one more sets of speakers. The audio processor 206 also performs any necessary conversion for the storage of the audio signals.

The video output from the input stream processor 204 is provided to a video processor 210. The video signal may be one of several formats. The video processor 210 provides, as necessary, a conversion of the video content, based on the input signal format. The video processor 210 also performs any necessary conversion for the storage of the video signals.

A storage device 212 stores audio and video content received at the input. The storage device 212 allows later retrieval and playback of the content under the control of a controller 214 and also based on commands, e.g., navigation instructions such as fast-forward (FF) and rewind (RW), received from a user interface 216 and/or touch panel interface 222. The storage device 212 may be a hard disk drive, one or more large capacity integrated electronic memories, such as static RAM (SRAM), or dynamic RAM (DRAM), or may be an interchangeable optical disk storage system such as a compact disk (CD) drive or digital video disk (DVD) drive.

The converted video signal, from the video processor 210, either originating from the input or from the storage device 212, is provided to the display interface 218. The display interface 218 further provides the display signal to a display device of the type described above. The display interface 218 may be an analog signal interface such as red-green-blue (RGB) or may be a digital interface such as HDMI. It is to be appreciated that the display interface 218 will generate the various screens for presenting the search results (e.g., in a three dimensional grid, two dimensional array, and/or a shelf as will be described in more detail below).

The controller 214 is interconnected via a bus to several of the components of the device 200, including the input stream processor 204, audio processor 206, video processor 210, storage device 212, and a user interface 216. The controller 214 manages the conversion process for converting the input stream signal into a signal for storage on the storage device or for display. The controller 214 also manages the retrieval and playback of stored content. Furthermore, the controller 214 can perform searching of content stored or to be delivered via the delivery networks.

The controller 214 is further coupled to control memory 220 (e.g., volatile or non-volatile memory, including RAM, SRAM, DRAM, ROM, programmable ROM (PROM), flash memory, electronically programmable ROM (EPROM), electronically erasable programmable ROM (EEPROM), etc.) for storing information and instruction code for controller 214. Control memory 220 may store instructions for controller 214. Control memory 220 may also store a database of elements, such as graphic elements containing content. The database may be stored as a pattern of graphic elements, such as graphic elements containing content, various graphic elements used for generating a displayable user interface for display interface 218, and the like. Alternatively, the memory may store the graphic elements in identified or grouped memory locations and use an access or location table to identify the memory locations for the various portions of information related to the graphic elements. Additional details related to the storage of the graphic elements will be described below. Further, the implementation of the control memory 220 may include several possible embodiments, such as a single memory device or, alternatively, more than one memory circuit communicatively connected or coupled together to form a shared or common memory. Still further, the memory may be included with other circuitry, such as portions of bus communications circuitry, in a larger circuit.

Optionally, controller 214 can be adapted to extract metadata, criteria, characteristics or the like from audio and video media by using audio processor 206 and video processor 210, respectively. That is, metadata, criteria, characteristics or the like that is contained in the vertical blanking interval, auxiliary data fields associated with video, or in other areas in the video signal can be harvested by using the video processor 210 with controller 214 to generate metadata that can be used for functions such as generating an electronic program guide having descriptive information about received video, supporting an auxiliary information service, and the like. Similarly, the audio processor 206 working with controller 214 can be adapted to recognize audio watermarks that may be in an audio signal. Such audio watermarks can then be used to perform some action such as the recognition of the audio signal, provide security which identifies the source of an audio signal, or perform some other service. Furthermore, metadata, criteria, characteristics or the like, to support the actions listed above can come from a network source which are processed by controller 214.

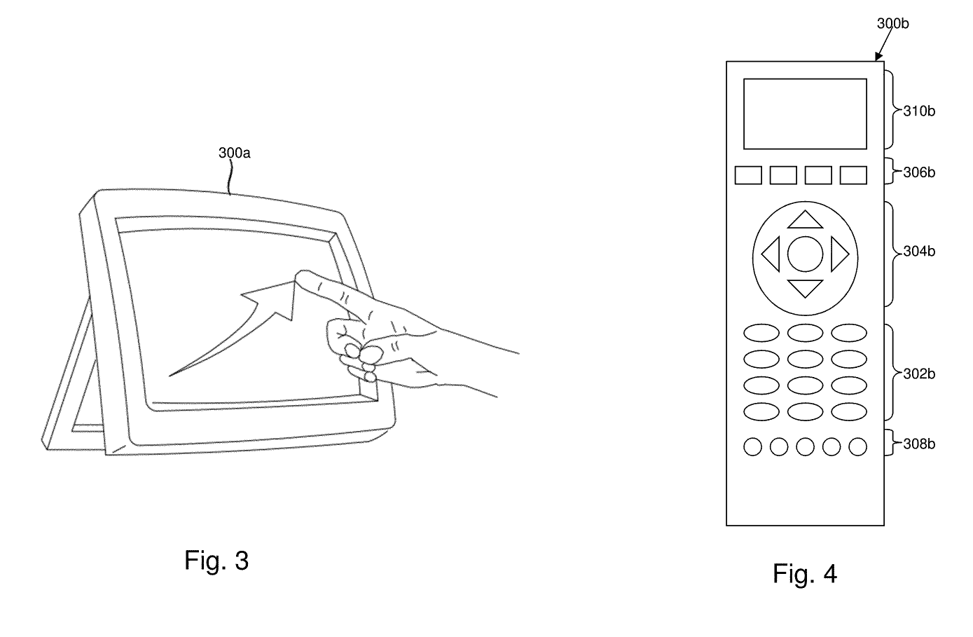

FIG. 3 and represent two exemplary input devices, 300a and 300b (hereinafter referred to collectively as input device 300), for use with the system described in FIGS. 1 and 2. The user input device 300 enables operation of and interaction with the user interface process according to invention principles. The input device may be used to initiate and/or select any function available to a user related to the acquisition, consumption, access and/or modification of multimedia content. FIG. 3 represents one exemplary tablet or touch panel input device 300a (which is the same as the touch screen device 116 shown in FIG. 1 and/or is an integrated example of media device 108 and touch screen device 116). The touch panel device 300a may be interfaced via the user interface 216 and/or touch panel interface 222 of the receiving device 200 in FIG. 2. The touch panel device 300a allows operation of the receiving device or set top box based on hand movements, or gestures, and actions translated through the panel into commands for the set top box or other control device. This is achieved by the controller 214 generating a touch screen user interface including at least one user selectable image element enabling initiation of at least one operational command. The touch screen user interface may be pushed to the touch screen device 300a via the user interface 216 and/or the touch panel interface 222. In an alternative embodiment, the touch screen user interface generated by the controller 214 may be accessible via a webserver executing on one of the user interface 216 and/or the touch panel interface 222. The touch panel 300 may serve as a navigational tool to navigate the grid display. In other embodiments, the touch panel 300a will additionally serve as the display device allowing the user to more directly interact with the navigation through the grid display of content. The touch panel device 300a may be included as part of a remote control device 300b containing more conventional control functions such as activator and/or actuator buttons such as is shown in FIG. 4. The touch panel 300a can also include at least one camera element and/or at least one audio sensing element.

In one embodiment, the touch panel 300a employs a gesture sensing controller or touch screen enabling a number of different types of user interaction. The inputs from the controller are used to define gestures and the gestures, in turn, define specific contextual commands. The configuration of the sensors may permit defining movement of a user's fingers on a touch screen or may even permit defining the movement of the controller itself in either one dimension or two dimensions. Two-dimensional motion, such as a diagonal, and a combination of yaw, pitch and roll can be used to define any three-dimensional motions, such as a swing. Gestures are interpreted in context and are identified by defined movements made by the user. Depending on the complexity of the sensor system, only simple one dimensional motions or gestures may be allowed. For instance, a simple right or left movement on the sensor as shown here may produce a fast forward or rewind function. In addition, multiple sensors could be included and placed at different locations on the touch screen. For instance, a horizontal sensor for left and right movement may be placed in one spot and used for volume up/down, while a vertical sensor for up and down movement may be placed in a different spot and used for channel up/down. In this way specific gesture mappings may be used. For example, the touch screen device 300a may recognize alphanumeric input traces which may be automatically converted into alphanumeric text displayable on one of the touch screen device 300a or output via display interface 218 to a primary display device.

The system may also be operated using an alternate input device 300b such as the one shown in FIG. 4. The input device 300b may be used to interact with the user interfaces generated by the system and which are output for display by the display interface 218 to a primary display device (e.g. television, monitor, etc). The input device of FIG. 4 may be formed as a conventional remote control having a 12-button alphanumerical key pad 302b and a navigation section 304b including directional navigation buttons and a selector. The input device 300b may also include a set of function buttons 306b that, when selected, initiate a particular system function (e.g. menu, guide, DVR, etc). Additionally, the input device 300b may also include a set of programmable application specific buttons 308b that, when selected, may initiate a particularly defined function associated with a particular application executed by the controller 214. As discussed above, the input device may also include a touch panel 310b that may operate in a similar manner as discussed above in FIG. 3A. The depiction of the input device in FIG. 4 is merely exemplary and the input device may include any number and/or arrangement of buttons that enable a user to interact with the user interface process according to invention principles. Additionally, it should be noted that users may use either or both of the input devices depicted and described in FIGS. 3 and 4 simultaneously and/or sequentially to interact with the system.

In another embodiment, the user input device may include at least one of an audio sensor and a visual sensor. In this embodiment, the audio sensor may sense audible commands issued from a user and translate the audible commands into functions to be executed by the user. The visual sensor may sense the user(s) present and match user information of the sensed user(s) to stored visual data in the usage database 120 in FIG. 1. Matching visual data sensed by the visual sensor enables the system to automatically recognize the user(s) present and retrieve any user profile information associated with those user(s). Additionally, the visual sensor may sense physical movements of at least one user present and translate those movements into control commands for controlling the operation of the system. In this embodiment, the system may have a set of pre-stored command gestures that, if sensed, enable the controller 214 to execute a particular feature or function of the system. An exemplary type of gesture command may include the user waving their hand in a rightward direction which may initiate a fast forward command or a next screen command or a leftward direction which may initiate a rewind or previous screen command depending on the current context. This description of physical gestures able to be recognized by the system is merely exemplary and should not be taken as limiting. Rather, this description is intended to illustrate the general concept of physical gesture control that may be recognized by the system and persons skilled in the art could readily understand that the controller may be programmed to specifically recognize any physical gesture and allow that gesture to be tied to at least one executable function of the system.

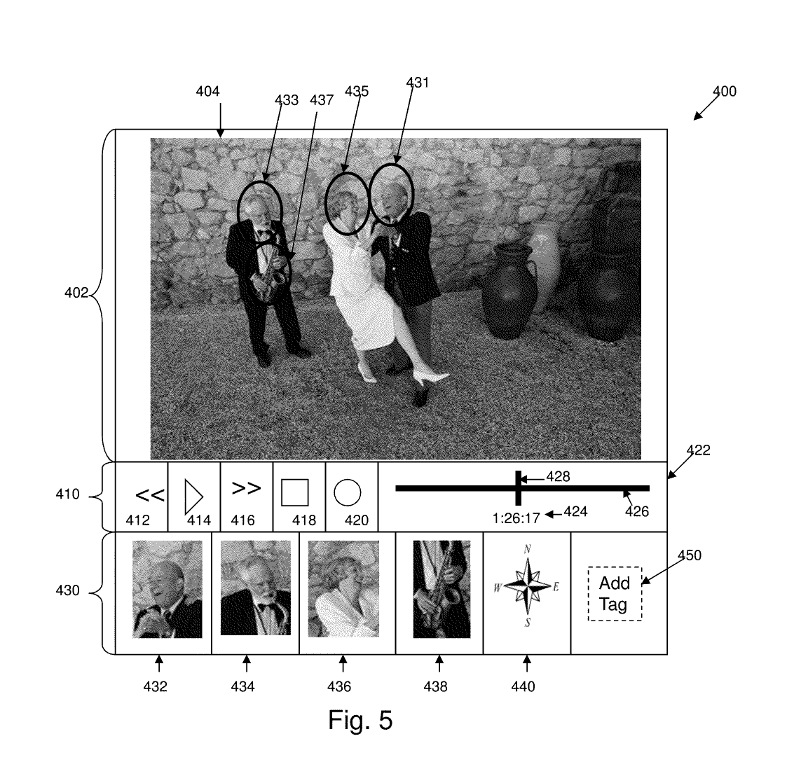

In the context of the present system, the input device 300 enables the user to interact with a plurality user interfaces. The user interfaces contain different types of user selectable image elements. The user selectable image element may be representative of at least one type of media object that is included in the media content being received and output for display. As used herein, the term multimedia content refers to audio-video data that may be acquired or otherwise received and which may be at least one of output for display to a user and stored in a storage device for later viewing. The multimedia content may be received live, in real-time, or may be a pre-recorded. Multimedia content is associated with an auxiliary media data file. The auxiliary media data file includes information describing at least one media object included in the multimedia content. The information in the auxiliary media data file includes position information describing the various positions of the respective media object within the multimedia content. It should be understood that the auxiliary media data file may be an actual file that is communicated from a content provider to the receiving device. Alternatively, the auxiliary media data file may be generated by the receiver device in response to receiving a data stream that includes auxiliary media data. The information may also include position description information describing each position of the media object. The information may also include media object description information that describes at least one characteristic of the media object. Additionally, the term media object refers to an item associated with the multimedia content, the selection of which results in execution of a further action. A media object may include any item, person, background, location or any other element of the multimedia content that may be displayed to a user for selection thereof. The further action resulting from the selection of an exemplary media object may be at least one of (a) skipping to another location within the media content that also includes the media object, (b) generating of a further user interface including a list of at least one other position within the multimedia content that includes the selected media object, (c) generating a further user interface that includes a listing of auxiliary information associated with the selected media object. Thus, by presenting media objects within a user interface, the user consuming the multimedia content can quickly navigate to additional positions of the multimedia content that also include the same media object. For example, the multimedia object may be a motion picture and each of the actors in the motion picture may be represented as individual media objects. A selectable image element representing each media object (actor) may be presented within a user interface and, in response to selection thereof, result in automatic skipping within the multimedia content to a subsequent position therein where that actor is once again shown (e.g. a subsequent scene). Alternatively, selection of the media object representing an actor may generate a further user interface including a list of at least one other position within the multimedia content where that media object (e.g. actor) is shown (e.g. a list of additional scenes in the motion picture that include that actor). The user interfaces according to invention principles will now be discussed with respect to FIGS. 5-7.

In the following description, it should be understood that all user interfaces including user selectable image elements may be generated by the controller 214 of FIG. 2 and output to the user via at least one of the use interface 216, the display interface 218 and/or the touch panel interface 222. Additionally, the interaction with the user interfaces generated by the controller 214 may be accomplished via the input device 300a and/or 300b such that any selection of an image element will be received and processed by the controller 214 resulting in one of (a) updating the currently displayed user interface in response to the data selected or entered by the user; and (b) generating a new user interface in response to the data selected or entered by the user.

FIGS. 5-7 represent interactive user interfaces generated by the controller 214 that enable the user to selectively navigate through multimedia media content being displayed via a plurality of user selectable media objects displayed within the user interface. In FIG. 5, the controller 214 generates a media navigation user interface 400. The media navigation user interface 400 includes a content section 402. The content section 402 includes the multimedia content 404 selected by the user. The content section 402 may show multimedia media content that is actively playing showing the multimedia content in action or may display a still image representative of the multimedia content at a particular point such as a when the multimedia content is paused by a user (e.g. a screen shot of the particular position within the multimedia content). In one embodiment, the media navigation user interface 400 may be selectively displayed on the touch screen input device 300a in response to the user pausing the active display of the multimedia content. In another embodiment, the media navigation interface 400 may be continually displayed on at least one of the touch screen input device 300a and the display device 114 (FIG. 1) thereby enabling the user to view the multimedia content 404 within the confines of the media navigation interface 400 to facilitate rapid navigation within the multimedia content 404.

The media navigation interface 400 also includes a media control section 410. The media control section 410 includes a plurality of user selectable image elements enabling the user to control various playback operations for the particular multimedia media content 404 displayed within the content section 402. For example, the media control section 410 may include a reverse seek button 412, a play button 414, a forward seek button 416, a stop button 418 and a record button 420. User selection of any of these buttons causes initiation of the standard operations known within the art of audio-visual display and need not be further discussed. The control section 410 may also include an information section 422. The information section 422 provides time and position information associated with a current state of the multimedia content 404 in content section 402. The information section may include a time bar 426 representing a length of the multimedia content 404. A selection bar 428 may also be included and is selectively positionable along the length of the timeline 426. User selection and movement within the timeline 426 advantageously enables the user to manually select a point within the multimedia content that is to be displayed within the content section 402. Moreover, the position of the selection bar 428 is continually updated in response to the playback of the multimedia content. The information section 422 may also include a time indicator that advantageously provides the user with specific time information associated with the multimedia content 404. For example, should the multimedia content be paused, as is shown in FIG. 5, the time indicator 424 will display the timestamp identifying the point at which the multimedia content 404 is paused. In the instance when the multimedia content 404 is being played back to the user, in addition to movement of the selection bar 428, the time information 424 within the information section 422 is continually updated to reflect a current position of the multimedia content 404.

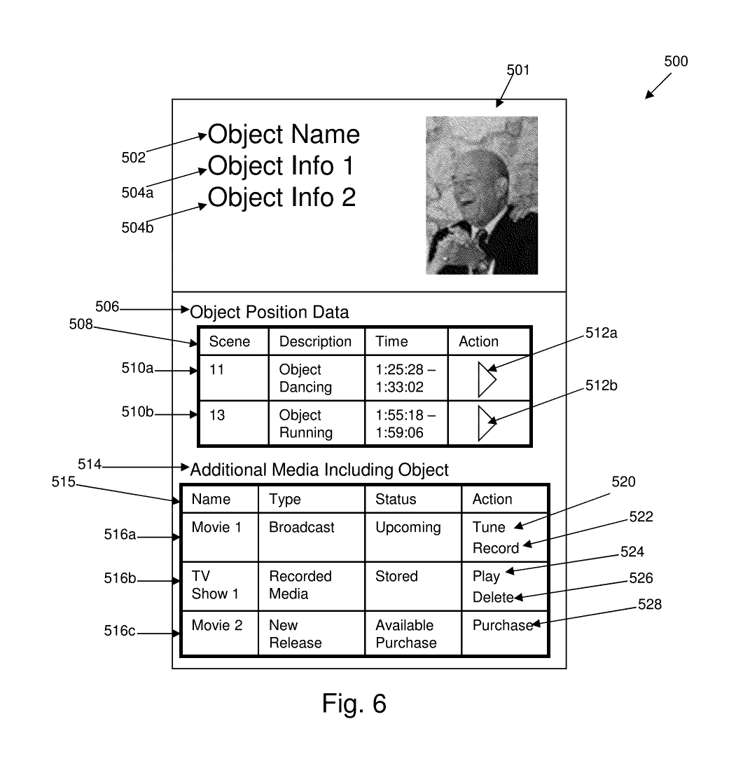

The navigation interface 400 further includes the media object section 430. The media object section 430 includes at least one media object image element (432, 434, 436, 438, 440 and 450) representing a particular media object within the multimedia content. The media object image elements are user selectable, and result in at least one further action being initiated by the controller 214. In one exemplary operation, selection of a respective media object image element results in the automatic skipping within the multimedia content 404 to a next position that includes the selected media object. In another embodiment, selection of a respective media object image element results in generation of a further user interface such as the one shown and discussed below in FIG. 6 that provides additional information about the selected media object.

Media objects within the multimedia content 404 are set forth in the auxiliary media data file associated with the multimedia content. The media objects in the auxiliary media data file may be provided by the content provider (e.g. cable provider, movie studio, etc). These media objects may represent any item or aspect of the multimedia content that is shown to the user. The media object may appear at least one of (a) more than one point within the multimedia content, and (b) a single point within the multimedia content. Media objects may include, but are not limited to, at least one of (a) an actor/actress in the multimedia content, (b) a character in the multimedia content, (c) an item/object in the multimedia content, (d) a particular location in the multimedia content, (e) an audio component of the multimedia content, (f) any other aspect of the multimedia content that occurs more than once within the content; and (g) an other aspect of the multimedia content that may be used to provide additional information to a user.

The auxiliary media data file may include an information element that at least one of (a) identifies a media object, (b) describes the identified media object, (c) identifies at least one position within the multimedia content at which the media object may be located, (d) describes at least one position at which the media object may occur, (e) identifies additional multimedia content that includes the particular media object (e.g. other movies, shows, etc), (f) includes access information enabling a user to access additional information associated with the media object, and (g) includes information identifying a level of relatedness of the particular media object with at least one other media object of the multimedia content. The types of information described above as being included in the auxiliary media data file are described for purposes of example only and any information describing any aspect of the multimedia content may be included as an information element in the auxiliary media data file. Additionally, each information element in the auxiliary media data file includes a unique identifier associated therewith. The unique identifier associated with each information element is used by the controller 214 in generating image elements for the media objects that are selectively displayed within the media object section 430 of media navigation interface 430. In one embodiment, the unique identifier may be obtained directly from within the multimedia content and be mapped directly to a portion of the multimedia content. In another embodiment, the unique identifier may be from a 3^{rd} party source and communicated with the auxiliary media data associated with the multimedia content.

The operation of the navigation interface 400 will now be described with respect to the multimedia content 404 being displayed within the content section 402. The following operation will be described with the multimedia content 404 being a motion picture. However, this description of a motion picture as the multimedia content is only to illustrate the principles of the present invention and should not be taken as limiting the present invention. Persons skilled in the art will understand the multimedia content 404 in content section 402 may be any type of audio-visual data.

The multimedia content 404 includes an associated auxiliary media data file. The auxiliary media data file may be received via the input signal receiver 202 for storage in the storage device 212. In the case that the auxiliary media data is communicated to the receiving device as a data stream, the auxiliary media data may be processed by the input stream processor 204 and stored in the storage device 212. The auxiliary media data may include a plurality of records including a plurality of fields corresponding to information elements describing a particular media object. In one embodiment, a media object record may be included for each instance that the respective media object occurs within the multimedia content. In another embodiment, the auxiliary media data file may group all of the same media objects together into respective records and further include sub-records including the information elements associated with the individual media object records. An exemplary format for the auxiliary media data file is shown in Table 1 which sets forth the field name of a particular record and a description of the type of data present in the field.

TABLE 1
Aux. Media Data File

| Field Name | Field Description/Type of Data |
|---|---|
| Media Object Name | The name of the media object to which |
| | this record applies |
| Media Object Type | Type of Media Object - e.g. actor, |
| | location, etc |
| Media Object identifier | Image file name and/or image file |
| | location that identifies the media object |
| Time Stamp - Start | Time stamp data identifying a time within |
| | the multimedia content that the media |
| | object appears |
| Time Stamp - Duration | Time stamp identifying a duration of time |
| | that the media object is shown; note, the |
| | duration applies directly to the time stamp |
| | indicated in the Time Stamp - Start Field |
| Time Stamp - Total | Time stamp information identifying each |
| | time the media object appears throughout |
| | the multimedia content |
| Other Media Content | Includes information identifying other |
| | multimedia content including this media |
| | object; may include multimedia content |
| | currently possessed or available or |
| | content that can be acquired from an |
| | external source/3^{rd} party |
| Media Object Description | Information describing the media object |
| Media Object Location | Real-world location associated with the |
| | media object in context of the current |
| | multimedia content (e.g. current scene |
| | was filmed in Maui, HI) |
| Media Object Location | Information about the real-world location |
| Description | listed in Media Object Location Field; |
| | may include data for accessing additional |
| | sources of information |
| Media Object Relatedness | Information identifying the relatedness of |
| | this media object with any other media |
| | object in the multimedia content; may |
| | also include information identifying other |
| | types of multimedia content including this |
| | object and any other media object in the |
| | current content (e.g. media objects |
| | representing two actors in this same |
| | movie may identify other movies that also |
| | include these two actors) |

Table 1 merely illustrates the types of information element fields that may be associated with a media object within the multimedia content. However, each record in the auxiliary media data file may include any number of information element fields that include any type of information associated with the media object.

In one exemplary operation, in response to a user pausing playback of the multimedia content 404, the controller 214 generates the navigation interface 400. The pausing of content playback may occur by initiating a pause command on any user input device 300. In generating the navigation interface 400, the controller 214 identifies a current time within the multimedia content and parses the auxiliary media data file to identify the media objects that are present at the current time. Upon identifying the media objects present at the current time, the controller 214 obtains the media object identifier associated with a respective media object and provides the media object identifier to one of the user interface 216, touch screen interface 222 and/or display interface 218 for inclusion as a user selectable media object image element in the media object section 430 of the navigation user interface 400.

For example, the multimedia content 404 may be a motion picture, and, at the current time, the motion picture is displaying a scene that includes two actors dancing with a third actor playing music. The controller 214 will parse the auxiliary media file to identify the two actors dancing and the actor playing music as respective media objects. The male actor dancing represents the first media object 431. The controller 214 uses the media object identifier associated with the first media object 431 to generate the media object image element 432 that may be selected by a user for inclusion in the media object section 430. The male actor playing music represents the second media object 433. The controller 214 uses the media object identifier associated with the second media object 433 to generate the media object image element 434 that may be selected by a user for inclusion in the media object section 430. The female actor dancing represents the third media object 435. The controller 214 uses the media object identifier associated with the third media object 435 to generate the media object image element 436 that may be selected by a user for inclusion in the media object section 430. In parsing the auxiliary media data file, the controller 214 may identify the music being played as a fourth media object 437, the associated media object identifier may be the instrument being played by the actor (e.g. second media object). The controller 214 uses the media object identifier associated with the fourth media object 437 to generate the media object image element 438 that may be selected by a user for inclusion in the media object section 430. A fifth media object representing the location of the present scene may also be identified from the auxiliary media data file by the controller 214. By example, additional identifiers associated additional media objects indicating additional location data can also be included in the object section 430 of navigation user interface 400. In this embodiment, such additional media object image elements can be represented by a generic location indicator.

By presenting the media object image elements 432, 434, 436, 438 and 440, the user may advantageously control navigation within the multimedia content 404 by selecting any of the media object image elements. Selection of any of the media object image elements automatically skips within the current multimedia content to a next position at which the selected media object is displayed. For example, selection of the first media object image element 432 causes the controller 214 to search the records of the auxiliary media data file to locate the selected media object and identify a next time at which the selected media object is present. The controller 214 automatically causes playback of the multimedia content beginning from the next time as indicated in the auxiliary media data file. This advantageously alleviates the need to manually search through the multimedia content to locate the next occurrence while ensuring that a next occurrence of the media object is not inadvertently missed during the manual seek process. In this example, selecting the first media object image element 432 representing the male actor dancing results in automatic skipping to a next position within the multimedia content that includes the male actor. In one embodiment, if the multimedia content is paused within a current scene, the automatic skipping to a next position may occur using data in the Time Stamp-Start Field that occurs later than an end time indicated in the Time Stamp-Duration field.

It is important to note that, in FIG. 5, the circles shown in the multimedia content 404 are intended to facilitate the understanding of the relationship of identified media object with the media object image elements presented in media object section 430. These circles are not actually displayed to the user within the navigation interface. Moreover, the display of five media object image elements is for purposes of example only and, depending on the particular position at which the content 404 is paused, there may be any number of identifiable media objects all of which may be presented in the media object section 403. In the instance where there are more identified media objects than are able to be displayed simultaneously, the media content section may include a scrolling feature allowing the user to selectively scroll and selectively change which media object image elements are currently displayed within the navigation interface 400.

In an optional embodiment, the media object section 430 may include an object tagging image element 450. By selecting the object tagging image element 450, the controller 214 initiates a tagging algorithm that enables the user to use the input device 300 to select at least a portion of the currently paused multimedia content 404 and identify the selected portion as a media object that can be selected by a user. The tagging algorithm responds to user input, for example, via touch screen interface, tracing a circle around a portion of the paused multimedia content. This automatically identifies the selected portion as a media object. Thereafter, the controller may generate a media object input user interface that includes a blank media data file record including any of the information element fields shown in Table 1. The user can selectively choose a media object identifier to be associated with the identified media object and enter data in each information element field that describes the media object identified by the user. The controller 214 may automatically update the auxiliary media data file to include the user-identified media object thereby enabling display of the user identified media object at any subsequent position within the multimedia content 404.

In another optional embodiment, selection of the first media object image element 432 representing the male actor that is dancing results in the controller 214 generating a media object information interface 500 shown in FIG. 6. All data shown in the media object interface 500 may be derived from the auxiliary media data file associated with the multimedia content being consumed by the user. In this embodiment, the media object information interface 500 includes a section that includes information describing the previously selected media object 431 associated with the first media object image element 432. For example, the interface 500 may include the media object identifier 501 providing a visual cue as to the nature of the media object as well as the name of the media object 502 (e.g. the name of the actor). The interface may also include at least one object information field 504a, 504b that includes any information about the media object. In the case where the object is an actor, information field 504a may include a birth date or age and information field 504b may include roles for which the actor is famous. These are merely described to illustrate the point that the interface 500 presents any type of information about the media object and any such information associated with the media object may be presented in one or more information fields 504a, 504b.

Also included in interface 500 is an object position section 506 that includes a listing of at least one other position in the current multimedia content that the selected media object appears. For example, in the present case, the selected media object is an actor and the object position data may represent various scenes in the movie at which the actor is present. As shown herein, the object position data is provided in an Object Position Table 506. Object position table 506 lists the scenes in which the actor appears along with description information about what the actor is doing in those subsequent scenes and the time duration of those scenes. As shown herein, the actor appears in scene 11 which, based on the time stamp associated therewith and shown in the information section 422 of FIG. 5, represents the current scene. A user can initiate playback of the current scene by selecting the play image element 512a. Selection of play image element 512a may result in playback at the beginning of the current scene. Alternatively playback can begin at the current time point. Additionally, the object position table 506 includes an entry for scene 13 which represents a subsequent position in the multimedia content in which the actor appears. In scene 13, the actor is described as running and the time stamp data indicates the start time, end time and duration of scene 13. A second play image element 512b is provided and, selection thereof, results in the automatic skipping to and playback of the beginning of scene 13 as per the time stamp data.

The interface 500 also includes an additional media section 514 that presents instances of additional multimedia content that includes the selected media object in an additional media table 515. The additional media table includes a first row 516a that identifies the name of the additional media (“Movie 1”), the manner in which the additional media is presented (“Broadcast”), status information (“Upcoming”) and at least one action item resulting in a particular action to be taken for the respective additional media. Because the first row of table 515 identifies the movie as “upcoming”, the action items may include Tune 520 resulting in the tuner tuning a channel on which Movie 1 is to be broadcast and/or Record 522 resulting in the controller 214 scheduling a recording of Movie 1 at the indicated time. A second row 516b identifies the additional media as “TV Show 1” that has been recorded and stored. The action items include Play 524, selection of which, results in the stored TV Show 1 being retrieved and played back on the display device 114 (FIG. 1). The action items may also include Delete which causes the stored TV Show to be deleted from the storage device 212. A third row 516c identifies the additional media as “Movie 2” that is a new release and is available for purchase. The action items associated with Movie 2 include Purchase 528 that initiates a multimedia content purchase algorithm that enables the user to enter payment information and purchase Movie 2 from the content provider and/or a 3^{rd} party.

The description of data displayed in FIG. 6 is described for purposes of example only and the interface 500 may selectively display any information element that is included in the auxiliary media data file and is associated with the selected media object.

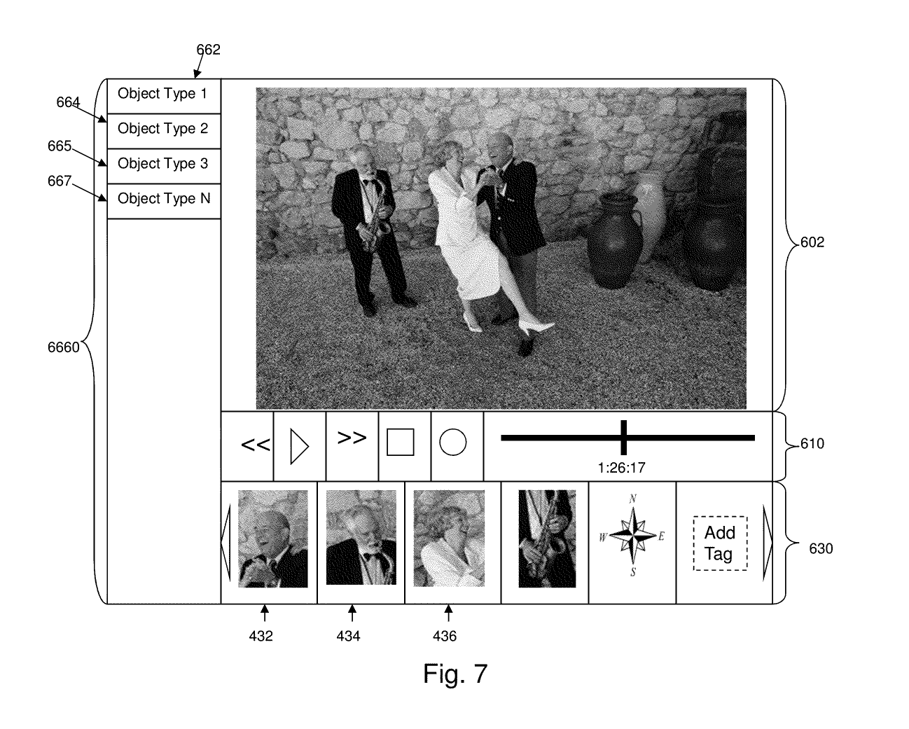

FIG. 7 represents another embodiment of the navigation user interface 600 in accordance with invention principles. The navigation user interface 600 includes the content section 602, control section 610 and media object section 630. These sections are similar in design and operation to their counterparts 402, 410 and 430, respectively, in FIG. 5 and need not be further described. The additional feature of navigation interface 600 relates to selection of the type of media objects able to be displayed in the media object section 630. Thus, interface 600 includes object type selection section 660 that includes at least one user selectable image element representing at least one type of media object included in the multimedia content currently being viewed by the user. The different object types included in the multimedia content may be included to populate section 660 by the controller 214 which parses the auxiliary data file to identify each unique type of media object included in the multimedia content. Upon identifying each type of media object, the controller 214 causes section 660 to be populated with user selectable image elements representative of the types of media objects. Selection of the image elements representative of the types of media objects results in the controller 214 automatically updating the media object image elements to be displayed within the media object section 630. In one embodiment, the navigation interface defaults to display all types of media objects resulting in any media object image element associated with a media object at the current time position to be displayed. In response to selection of a respective type of media object from within section 660, the controller 214 automatically modifies the media object section to omit media object image elements of the type selected in section 660. One skilled in the art will appreciate that the opposite operation may also be implemented whereby the system defaults to display no media objects and, in response to selection of object types in section 660, the controller 214 automatically modifies the media object section 630 to include the selected object types.

In exemplary operation, the controller has determined that the current multimedia content includes Object Type 1 662, Object Type 2 664, Object Type 3 665 and Object Type N present in object type selection section 667. In this embodiment, Object Type 1 662 may represent actors/actresses and selection of Object Type 1 image element 662 results in the controller 214 displaying the first, second and third media object image elements 432, 434 and 436, respectively because these media object image elements are associated with actors/actresses. Object Type 2 664 may represent an item in the current scene and selection of the Object Type 2 664 image element results in the controller 214 displaying the fourth media object image element 438 because the fourth media object image element represents a musical instrument (e.g. an item in the scene). Object Type 3 665 may represent a location at which the current scene takes place and selection of the Object Type 3 665 image element results in the controller 214 displaying the fifth media object image element 440 because the fifth media object image element represents location information. The inclusion of Object Type N is provided only as an example to illustrate the section 660 may be populated with any number of object types that are present in the multimedia content thereby advantageously filtering the type of media object image elements that will be presented. Because any aspect of the multimedia content may be tagged and identified as a media object, filtering the types of media objects to be displayed in the media object section 630 advantageously enables the user to be more targeted in the types of objects that are used to navigate within the multimedia media content.

The above discussed operation is described with respect to the multimedia content being paused. However, in an optional embodiment, the navigation user interfaces 400 or 600 are continually displayed and output to a second screen device, e.g. a tablet, thus enabling the improved navigation within the multimedia content in real time. In this embodiment, the controller 214 continually queries the auxiliary media data file to identify media objects from within the multimedia content and that are presently being displayed either within the content section 402/602 or on a primary display device 114 (FIG. 1). The controller 214, in response to continually identifying media objects, automatically updates the media object section 430/630 with media object image elements corresponding to the identified media objects thereby presenting the media object image elements in real-time and enabling real-time navigation within the multimedia content. The navigation and automatic skipping to a later position including the media object may be realized on the display device 114 or on the touch screen interface. In another embodiment, navigation may be realized on the display device 114 while the controller generates the media object information interface 500 of FIG. 6 and outputs the generated interface 500 to the touch screen display device thereby advantageously facilitating quick navigation within the multimedia content while simultaneously providing the user with media object information on the touch screen device via the media object information interface 500 of FIG. 6.

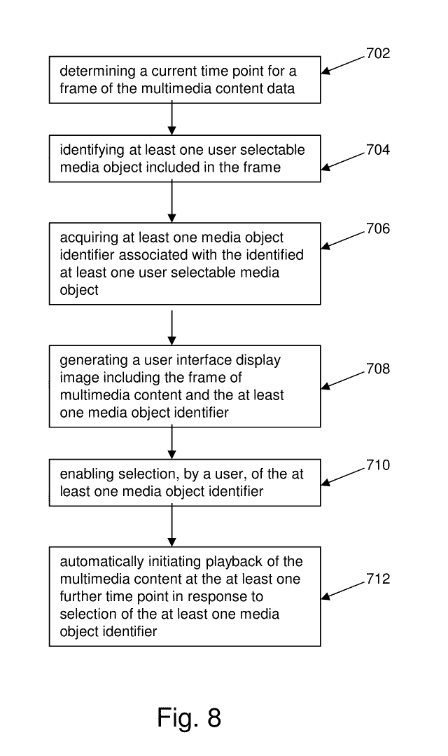

FIG. 8 is a flow diagram detailing operation of the system in accordance with invention principles. The flow diagram details an algorithm for operating the system that interacts with multimedia content data. At step 702, a current time point for a frame of the multimedia content data is determined. In one embodiment, step 702 may occur after pausing playback of the multimedia content data. At step 704, at least one user selectable media object included in the frame at the current time point and that occurs at least one further time point of the multimedia content data is identified.

In one embodiment, the media object includes at least one of (a) an actor/actress in the multimedia content, (b) a character in the multimedia content, (c) an item/object in the multimedia content, (d) a particular location in the multimedia content, (e) an audio component of the multimedia content, (f) any other aspect of the multimedia content that occurs more than once within the content, and (g) an other aspect of the multimedia content that may be used to provide additional information to a user.

In another embodiment, the identification step in 704 occurs by receiving an auxiliary media data file associated with the multimedia content data, the auxiliary media data file including at least one record corresponding to the at least one media object, parsing the at least one record of the auxiliary media data file based on the determined current time to identify a presence of at least one media object at the current time and outputting user selectable data representing at least one media object at the current time for inclusion into the user interface.

At least one media object identifier associated with the identified at least one user selectable media object is acquired in step 706. In one embodiment, step 706 may occur using an auxiliary media data file that includes media object identifiers associated with each of the at least one media object from which the at least one media object identifier is obtained. In another embodiment, step 706 may include using an auxiliary media data file that includes information describing respective media objects and using the information describing respective media objects to search an external source for data to be used as the media object identifier.

A user interface display image including the frame of multimedia content and the at least one media object identifier is generated in step 708. In one embodiment, step 708 may be performed using an auxiliary media data file associated with the multimedia content, the auxiliary media data file including all media objects included in the multimedia content data and identifies each point in time that each media object occurs in the multimedia content data. In another embodiment, step 708 may further include, for each media object identified at the current time, associating data representing a point in time subsequent to the current time with the media object identifier and inserting the media object identifier having the data representing the subsequent point in time into the user interface enabling the user to skip to the at least one subsequent point in time within the multimedia content upon selection of the media object identifier. In a further embodiment, step 708 may also include continually updating the generated user interface during playback with media object identifiers associated with identified media objects in the multimedia content data at the current time. In another optional embodiment, step 708 may also include generating a user selectable image element enabling a user to identify, as a media object, at least a portion of the frame of the multimedia content.

In step 710, the generated user interface enables selection, by a user, of the at least one media object identifier and, in step 712, playback of the multimedia content at the at least one further time point is automatically initiated in response to selection of the at least one media object identifier. In another embodiment, 712 may also result in generating a second user interface in response to selection of the at least one media object. In this embodiment, the second user interface includes the media object identifier associated with the selected media object, information describing the selected media object and at least one action image element for initiating at least one action associated with the media object. In a further embodiment, the information describing the selected media object includes time stamp data identifying each instance the media object appears within the multimedia content data and an action image element associated with each instance the media object appears, and activation of the action image element initiates playback of the multimedia content at a respective instance associated with the selected media object. In yet a further embodiment, the information describing the selected media object includes at least one other multimedia content data including the selected media object and provides an action image element associated with each of the at least one other multimedia content data, wherein selection of a respective action image element initiates at least one of (a) initiating a purchase of the at least one other multimedia content data, (b) tuning to a channel on which the at least one other multimedia content data is being transmitted, (c) scheduling a recording of the at least one other multimedia content data, and (d) deleting a previously recorded instance of the at least one other multimedia content data.

In an optional embodiment of the invention, Boolean logic sequences can be used to include groups of multiple objects or exclude certain selected objects from a search. For example, if a scene displays four objects, a user can select objects 1 and 2 (with an “AND”) combination and select object 3 (with a “NOT”). The basis of this search would have to require both objects 1 and 2 and exclude object 3 from any search results. Additional operators can be used such as OR, XOR, and the like. The Boolean operators can be added by using an user interface or alphanumeric entry in accordance with the disclosed principles above.

Although embodiments which incorporate the teachings of the present disclosure have been shown and described in detail herein, those skilled in the art can readily devise many other varied embodiments that still incorporate these teachings. Having described preferred embodiments of a system, method and user interface for content search (which are intended to be illustrative and not limiting), it is noted that modifications and variations can be made by persons skilled in the art in light of the above teachings. It is therefore to be understood that changes may be made in the particular embodiments of the disclosure disclosed which are within the scope of the disclosure as outlined by the appended claims.

1. A method of interacting with content data, the method comprising:
determining a current time point for a frame of the content data;
identifying at least one user selectable object included in the frame at the current time point and that occurs at least one further time point of the content data;
acquiring at least one object identifier associated with the identified at least one user selectable object;
generating a user interface display image including the frame of content and the at least one object identifier;
enabling selection, by a user, of the at least one object identifier; and
automatically initiating playback of the content at the at least one further time point in response to selection of the at least one media object identifier.

2. The method of claim 1, wherein the object includes at least one of (a) an actor/actress in the content, (b) a character in the content, (c) an item/object in the content, (d) a particular location in the content, (e) an audio component of the content, (f) any other aspect of the content that occurs more than once within the content, and (g) an other aspect of the content that may be used to provide additional information to a user.

3. The method of claim 1, wherein prior to the step of determining, further comprises pausing playback of the content.

4. The method of claim 1, wherein the activity of identifying at least one media object further comprises
receiving an auxiliary data file associated with the content data, the auxiliary data file including at least one record corresponding to the at least one object;
parsing the at least one record of the auxiliary data file based on the determined current time to identify a presence the at least one object at the current time; and
outputting user selectable data representing the at least one object at the current time for inclusion into the user interface.

5. The method of claim 4, wherein the auxiliary data file includes object identifiers associated with each of the at least one media object;
and acquiring at least one media object identifier obtains the object identifiers from the auxiliary data file.

6. The method of claim 4, wherein the auxiliary data file includes information describing respective objects, and acquiring the at least one object identifiers further comprises
using the information describing respective objects to search an external source for data to be used as the object identifier.

7. The method of claim 1, wherein the content data includes an auxiliary data file associated therewith, the auxiliary data file including all objects included in the content data and identifies each point in time that each object occurs in the content data.

8. The method of claim 7, wherein the activity of generating the user interface includes
for each object identified at the current time,
associating data representing a point in time subsequent to the current time with the object identifier, and
inserting the object identifier having the data representing the subsequent point in time into the user interface enabling the user to skip to the at least one subsequent point in time within the content upon selection of the media object identifier.

9. The method of claim 8, further comprising continually updating the generated user interface during playback with object identifiers associated with identified media objects in the content data at the current time.

10. The method of claim 1, wherein the activity of generating the user interface further comprises
generating a user selectable image element enabling a user to identify, as a object, at least a portion of the frame of the content.

11. The method of claim 7, further comprising
generating a second user interface in response to selection of the at least one object, the second user interface including
the object identifier associated with the selected object;
information describing the selected object; and
at least one action image element for initiating at least one action associated with the object.

12. The method of claim 11, wherein the information describing the selected object includes time stamp data identifying each instance the object appears within the content data and an action image element associated with each instance the object appears, and activation of the action image element initiates playback of the content at a respective instance associated with the selected object.

13. The method of claim 11, wherein the information describing the selected object includes at least one other content data including the selected object and further comprising
providing an action image element associated with each of the at least one other content data, wherein selection of a respective action image element initiates at least one of (a) initiating a purchase of the at least one other content data, (b) tuning to a channel on which the at least one other content data is being transmitted, (c) scheduling a recording of the at least one other content data, and (d) deleting a previously recorded instance of the at least one other content data.

14. An apparatus for interacting with content data comprising:
a controller for
determining a current time point for a frame of the content data;
identifying at least one user selectable object included in the frame at the current time point and that occurs at least one further time point of the content data; and
acquiring at least one object identifier associated with the identified at least one user selectable object;
a user interface generator coupled to the controller for generating a user interface display image including the frame of content and the at least one object identifier, the generated user interface enables selection, by a user, of the at least one object identifier and the controller automatically initiates playback of the content at the at least one further time point in response to selection of the at least one object identifier.

15. The apparatus of claim 14, wherein the media object includes at least one of (a) an actor/actress in the content, (b) a character in the content, (c) an item/object in the content, (d) a particular location in the content, (e) an audio component of the content, (f) any other aspect of the content that occurs more than once within the content, and (g) an other aspect of the content that may be used to provide additional information to a user.

16. The apparatus of claim 14, wherein the controller pauses playback of the content prior to identifying the at least one object.

17. The apparatus of claim 14, wherein the controller identifies the at least one object using an auxiliary data file associated with the content data, the auxiliary data file including at least one record corresponding to the at least one object and parsing the at least one record of the auxiliary data file based on the determined current time to identify a presence of the at least one object at the current time for inclusion in the user interface.

18. The apparatus of claim 17, wherein the auxiliary data file includes object identifiers associated with each of the at least one object; and acquiring at least one media object identifier obtains the object identifiers from the auxiliary data file.

19. The apparatus of claim 17, wherein the auxiliary data file includes information describing respective objects, and the controller acquires the at least one object identifiers using the information describing respective objects to search an external source for data to be used as the object identifier.

20. The apparatus of claim 14, wherein the content data includes an auxiliary data file associated therewith, the auxiliary data file including all objects included in the content data and identifies each point in time that each object occurs in the content data.

21. The apparatus of claim 20, wherein the generated user interface includes, for each object identified at the current time, a object identifier having data representing a subsequent point in time enabling the user to skip to the at least one subsequent point in time within the content upon selection of the object identifier.

22. The apparatus of claim 21, wherein the user interface generator continually updates the generated user interface during playback with object identifiers associated with identified media objects in the content data at the current time.

23. The apparatus of claim 14, wherein the user interface generator generating a user selectable image element enabling a user to identify, as a object, at least a portion of the frame of the content.

24. The apparatus of claim 21, wherein the user interface generator generates a second user interface in response to selection of the at least one object, the second user interface including
the object identifier associated with the selected object;
information describing the selected object; and
at least one action image element for initiating at least one action associated with the object.

25. The apparatus of claim 24, wherein the information describing the selected object includes time stamp data identifying each instance the object appears within the content data and an action image element associated with each instance the object appears, and activation of the action image element initiates playback of the content at a respective instance associated with the selected object.

26. The apparatus of claim 24, wherein the information describing the selected object includes at least one other content data including the selected object and includes an action image element associated with each of the at least one other content data, wherein selection of a respective action image element initiates at least one of (a) initiating a purchase of the at least one other content data, (b) tuning to a channel on which the at least one other content data is being transmitted, (c) scheduling a recording of the at least one other content data, and (d) deleting a previously recorded instance of the at least one other content data.
